(19) United States
(12) Patent Application Publication
(10) Pub. No.: US 2007/0101509 A1
(43) Pub. Date: May 10, 2007

(54) Method for the production of leather and semifinished products, and formulations that are suitable therefor

(75) Inventors: Stephan Huffer, Ludwigshafen (DE); Tilman Ludecke Taeger, Seeheim-Jugenheim (DE); Volker Bach, Neustadt (DE); Matthias Kluglein, Ludwigshafen (DE); Gunther Pabst, Neumarkt (DE); Oliver Reese, Mannheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Akiengesellschaft, Ludwigshafen (DE)

(21) Appl. No.: 10/572,547

(22) PCT Filed: Sep. 17, 2004
(86) PCT No.: PCT/EP04/10437

§ 371 Date: Mar. 17, 2006

(30) Foreign Application Priority Data
Sep. 26, 2003 (DE) 103 45 097.1

(51) Int. Cl. C14C 1/00

(52) U.S. Cl. 8/94.15

(57) ABSTRACT

Semifinished products or leather are or is produced by a process in which pelts, pickled pelts or semifinished products are treated with a) at least one sheet silicate and b) at least one copolymer which is obtainable by copolymerization of at least one ethylenically unsaturated dicarboxylic anhydride (A), derived from at least one dicarboxylic acid of 4 to 8 carbon atoms, at least one vinylaromatic compound (B1) or
at least one oligomer (B2) of branched or straight-chain C₂-C₁₀-alkene, at least one oligomer having an average molecular weight Mₙ of from 300 to 5 000 g/mol or being obtainable by oligomerization of at least 3 equivalents of C₂-C₁₀-alkene, and optionally at least one ethylenically unsaturated monomer (C) differing from (A) and having at least one hetero atom, and reaction with
at least one compound (D) of the formula I a or I b 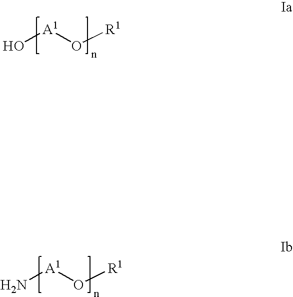 and optionally hydrolysis with water or aqueous alkaline solution, where, in formula I a and I b,
A¹ are identical or different and are C₂-C₆-alkylene
R¹ is linear or branched C₁-C₂₀-alkyl and n is an integer from 1 to 200.

The present invention relates to a process for the production of semifinished products or leather by treating pelts, pickled pelts or semifinished products with

(a) at least one sheet silicate and

(b) at least one copolymer which is obtainable by copolymerization of

at least one ethylenically unsaturated dicarboxylic anhydride (A), derived from at least one dicarboxylic acid of 4 to 8 carbon atoms,

at least one vinylaromatic compound (B1) or

at least one oligomer (B2) of branched or straight-chain C₂-C₁₀-alkene, at least one oligomer having an average molecular weight Mₙ of from 300 to 5 000 g/mol or being obtainable by oligomerization of at least 3 equivalents of C₂-C₁₀-alkene,

and

optionally at least one ethylenically unsaturated monomer (C) differing from (A) and having at least one hetero atom,

and reaction with

at least one compound (D) of the formula I a or I b 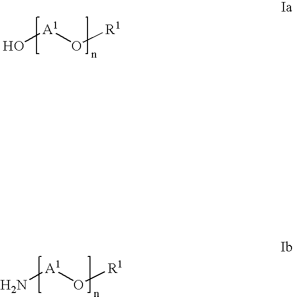
and optionally hydrolysis with water or an aqueous alkaline solution,
where, in formula I a and I b,
A¹ are identical or different and are C₂-C₆-alkylene,
R¹ is linear or branched C₁-C₂₀-alkyl, and
n is an integer from 1 to 200.

The comonomers defined above are also referred to below as copolymer (b) or as (b) copolymer.

The present invention furthermore relates to formulations comprising

(a) at least one sheet silicate and

(b) at least one copolymer which is obtainable by copolymerization of

at least one ethylenically unsaturated dicarboxylic anhydride (A), derived from at least one dicarboxylic acid of 4 to 8 carbon atoms,

at least one vinylaromatic compound (B1) or

at least one oligomer (B2) of branched or straight-chain C₂-C₁₀-alkene, at least one oligomer having an average molecular weight Mₙ of from 300 to 5 000 g/mol or being obtainable by oligomerization of at least 3 equivalents of C₂-C₁₀-alkene,

and

optionally at least one ethylenically unsaturated monomer (C) differing from (A) and having at least one hetero atom,

and reaction with

at least one compound (D) of the formula I a or I b 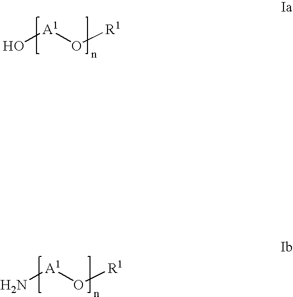
and optionally hydrolysis with water on an aqueous alkaline solution,
where, in formulae I a and I b,
A¹ are identical or different and are C₂-C₆-alkylene,
R¹ is linear or branched C₁-C₂₀-alkyl, and
n is an integer from 1 to 200.

The present invention furthermore relates to semifinished products and leather produced by the novel process, a process for the preparation of novel formulations and the use of novel semifinished products and novel leather.

Chrome tanning has been an important chemical treatment in leather production for more than 100 years, cf. for example Ullmann's Encyclopedia of Industrial Chemistry, Volume A15, pages 259 to 282 and in particular page 268 et seq., 5th Edition (1990), Verlag Chemie Weinheim. For ecological reasons, however, alternatives to chrome tanning have been sought. In the conventional chrome tanning, chromium salts in an amount of from 1.5 to 8% by weight, based on the pelt weight of the leather, or even more are made available. Of this, a considerable part is generally not bound and enters the wastewater. Although it is possible to free the wastewater from considerable amounts of chromium by chemical treatment with, for example, lime and iron salts, chromium-containing sludges are obtained and have to be disposed of on special landfills or worked up by an expensive procedure.

Moreover, chromium-containing leather wastes which may account for from about 8 to 15% by weight, based on the hide weight, and likewise have to be disposed of by an expensive procedure are obtained, for example in the splitting of the hides and in the leveling of the leather.

There has been no lack of attempts to reduce the chromium pollution of the wastewaters by, for example, recycling the chrome tanning liquors or chromium recycling processes. However, these processes were on the whole unsatisfactory and in particular not capable of solving the problem of chromium-containing leather wastes.

Processes in which some or all of the chromium is replaced by organic tanning agents are furthermore known. The use of the syntans, i.e. sulfonated condensates of formaldehyde and phenol or sulfonated naphthalene/formaldehyde condensates, may be mentioned. The use of vegetable tanning agents may furthermore be mentioned. Both classes of tanning agents however give rise to a high COD of the wastewaters and, for environmental reasons, are likewise not acceptable. Moreover, it has been found that the lightfastness of the leathers with the use of sulfonated phenol/formaldehyde condensates is often unsatisfactory (Ullmann's Encyclopedia of Industrial Chemistry, Volume A15, pages 259 to 282 and in particular page 270 et seq., 5th Edition (1990), Verlag Chemie Weinheim).

Furthermore, tanning with the use of aldehydes, in particular dialdehydes, for example glutaraldehyde, is known, cf. for example H. Herfeld, Bibliothek des Leders, Volume III, page 191, Umschau Verlag Frankfurt/Main, 1984. However, the fact that the shrinkage temperatures are not above 70° C. and that the semifinished products produced can therefore be hydroextracted only to an insufficient extent when small amounts of glutaraldehyde, for example from 0.5 to 0.9% by weight, based on the pelt weight, are used is disadvantageous. During the shaving, glue formation occurs on the flesh side of the leather and adversely affects the quality of the leather.

In the case of larger amounts of glutaraldehyde used during the pretanning, it is observed that in general completely tanned leather is obtained and that subsequent variable processing, as desired by many tanneries, is no longer possible.

It is known that glutaraldehyde can be used in partially or completely acetalated form for tanning, for example as methylacetal (Ullmann's Encyclopedia of Industrial Chemistry, Volume A15, pages 259 to 282 and in particular page 273 et seq., 5th Edition (1990), Verlag Chemie Weinheim). However, the tanned semifinished products described generally tend to yellow rapidly.

Furthermore, it is observed that semifinished products and leather pretanned with glutaraldehyde are in many cases difficult to shave. The shaving knives tend to stick and have to be cleaned.

It is an object of the present invention to provide novel processes for the production of semifinished products and leather, which avoids the abovementioned disadvantages. In particular, it is an object of the present invention to provide tanning agents which avoid the disadvantages described above.

We have found that this object is achieved by the processes, defined at the outset, for the production of semifinished products or leather.

It is possible within the scope of the present invention to start from pickled pelts or pelts and to obtain semifinished products or leather by the novel treatment. It is also possible within the scope of the present invention to start from semifinished products and to obtain leather by the novel treatment.

In an embodiment of the present invention, pelts, pickled pelts or semifinished products of animal hides, for example hides of cattle, pigs, goats, sheep or game, such as deer. It is not important for the novel process whether the animals were killed, for example by slaughtering, or died of natural causes. The animal hides may have been freed from horny substances by methods known per se, for example by liming with bases, such as lime and sulfur-containing reagents, such as NaHS or Na₂S or thioglycolic acid or 2-mercaptoethanol or 1,4-dimercaptobutane-2,3-diol.

Furthermore, the limed hides (pelts) may have been delimed by conventional methods, bated and subjected to mechanical operations, for example for fleshing the hides. Moreover, limed hides may already have been pickled, in which case the term pickled pelts is used.

In another embodiment of the present invention, semifinished products which may already have been subjected to pretanning or main tanning with one or more conventional tanning agents are used as starting materials, it being possible to refer to semifinished products as wet blue or wet white.

According to the invention, pelts, pickled pelts or semifinished products are treated with

(a) at least one sheet silicate and

(b) at least one copolymer.

Sheet silicates used according to the invention as (a) are known per se and are in general aluminosilicates which occur, for example, as weathering products of primary alumino silicates, i.e. from compounds containing silica and aluminum dioxide in which silicon is usually tetrahedrally coordinated and aluminum usually octahedrally coordinated, and which occur in nature, for example, in the form of clay minerals. Sheet silicates may be referred to as phyllosilicates and, in the context of the present invention, also comprise leaf silicates and ribbon silicates. The present invention is not restricted to the use of naturally occurring clay minerals; it is possible to use modified clay minerals as sheet silicates or synthetic sheet silicates.

In an embodiment of the present invention, sheet silicates (a) are selected from phyllosilicates such as kaolinites, muscovites, montmorillonites, smectites and bentonites, in particular hectorites.

In an embodiment of the present invention, sheet silicates (a) chosen are those sheet silicates which have a number average particle diameter of up to 2 μm, preferably up to 1 μm, it being possible to determine the particle diameter and the particle diameter distribution, for example, by combined laser light diffraction and light scattering according to ISO 13320-1. Suitable apparatuses for carrying out combined laser light diffraction and light scattering according to ISO 13320-1 are sold, for example, by Malvern.

In the context of the present invention, modified clay minerals are understood as meaning in particular those sheet silicates which are obtained from natural clay minerals by establishing specific particle diameter distributions.

In an embodiment of the present invention, those sheet silicates which are prepared during the novel treatment of pelts, pickled pelts or semifinished products by delamination of natural clay minerals are chosen as sheet silicate (a). For this purpose, it is possible to use clay minerals which have a mean particle diameter of up to 50 μm or more and are delaminated in situ during the novel treatment. When choosing the corresponding clay minerals, it must be ensured that the clay minerals are delaminated under treatment conditions according to the invention. This can be effected, for example, by delamination tests which are carried out separately. Preferably, delamination tests are carried out in such a way that a clay mineral is suspended in water, for example in at least 15 ml of water per g of clay mineral, preferably at least 19 ml of water per g of clay mineral, and is stirred, for example at 250 rpm or more. Stirring can be effected over a period of at least 15, preferably at least 30, minutes. If a particle diameter determination, for example according to ISO 13320-1, shows that the mean particle diameter (number average) is 2 μm or less, preferably 1 μm or less, or, after delamination tests, the clay minerals consist of a finely divided fraction whose particles have a number average particle diameter of from 0.01 to 0.5 μm and a coarser-particle fraction whose particles have a number average particle diameter from 1 to 5 μm, preferably from 1.1 to 2 μm, such clay minerals are suitable for use in the novel process.

In a preferred embodiment of the present invention, those sheet silicates which are prepared in situ during the use in the novel process by delamination of a mixture of natural clay minerals, for example of mixtures of kaolinite and bentonite or of mixtures of kaolinite and montmorillonite, are chosen as the sheet silicate (a).

In a preferred embodiment of the present invention, those sheet silicates which have been prepared in situ during the use in the novel process by delamination of a mixture of natural clay minerals and which have a bimodal particle diameter distribution after the delamination, for example in delamination tests, are chosen as the sheet silicate (a). For example, those sheet silicates which, after delamination, consist of a finely divided fraction whose particles have a number average particle diameter of from 0.01 to 0.5 μm and a coarser-particle fraction whose particles have a number average particle diameter of from 1 to 5 μm, preferably from 1.1 to 2 μm, can be used. The weight ratio of particles of the finely divided fraction to particles of the coarse-particled fraction may be, for example, from 1:10 to 10:1, preferably from 1:5 to 5:1.

In an embodiment of the present invention, those sheet silicates which have been prepared by delamination of natural clay minerals before use in the novel process are chosen as the sheet silicate (a). The delamination is preferably carried out on the basis of delamination tests in such a way that the clay mineral is suspended in water, for example in at least 15 ml of water per g of clay mineral, preferably at least 19 ml of water per g of clay mineral, and is stirred, for example at 250 rpm or more. Stirring can be effected over a period of at least 15, preferably at least 30, minutes.

In a special embodiment of the present invention, those sheet silicates which have been prepared by delamination of a mixture of natural clay minerals before use in the novel process, for example of mixtures of kaolinite and bentonite or of mixtures of kaolinite and montmorillonite, are chosen as the sheet silicate (a).

In a special embodiment of the present invention, those sheet silicates which have been prepared by delamination of a mixture of natural clay minerals before use in the novel process and which have a bimodal particle diameter distribution after the delamination are chosen as the sheet silicate (a). For example, it is possible to use those sheet silicates which, after delamination, consist of a finely divided fraction whose particles have a number average particle diameter of from 0.01 to 0.5 μm and a coarser-particle fraction whose particles have a number average particle diameter of from 1 to 5 μm, preferably from 1.1 to 2 μm. The weight ratio of particles of the finely divided fraction to particles of the coarse-particle fraction may be, for example, from 1:10 to 10:1, preferably from 1:5 to 5:1.

In an embodiment of the present invention, preferably organic substances which are capable of forming hydrogen bridges with sheet silicates are added to the sheet silicate (a) before or during the novel treatment of pelts, pickled pelts or semifinished products. Examples of such organic substances are urea, alcohols, polyols, ethylene carbonate, propylene carbonate, organic amides, urethanes, saccharides, derivatives of saccharides, such as nitrocellulose, sulfitocellulose and 2-ethylhexylcellulose.

Copolymers used according to the invention as (b) comprise, as comonomers in the form of polymerized units:

at least one, ethylenically unsaturated dicarboxylic anhydride (A), derived from at least one dicarboxylic acid of 4 to 8 carbon atoms, for example maleic anhydride, itaconic anhydride, citraconic anhydride, and methylenemalonic anhydride, preferably itaconic anhydride and maleic anhydride, very particularly preferably maleic anhydride;
at least one vinylaromatic compound (B1), for example of the formula V 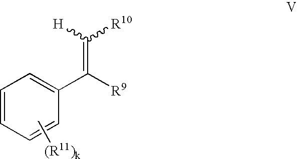
where R⁹ and R¹⁰, independently of one another, are each hydrogen, methyl or ethyl, R¹¹ is methyl or ethyl and k is an integer from 0 to 2, R⁹ and R¹⁰ are each preferably hydrogen and k is preferably 0;
or comonomers (B2).

Suitable comonomers (B2) are oligomers of ethylene, of propylene or of straight-chain or preferably branched C₄-C₁₀-olefins, at least one oligomer having an average molecular weight Mₙ of from 300 to 5 000 g/mol or being obtainable by oligomerization of at least 3, preferably at least 4, equivalents of C₂-C₁₀-alkene. Examples are oligomers of propylene, isobutene, 1-pentene, 2-methylbut-1-ene, 1-hexene, 2-methylpent-1-ene, 2-methylhex-1-ene, 2-ethylpent-1-ene, 2-ethylhex-1-ene and 2-propylhept-1-ene, 1-octene and 1-decene, isobutene being very particularly preferred.

Comonomers (B) have an ethylenically unsaturated group which may be present in the form of a vinyl, vinylidene or alkylvinylidene group.

Co-oligomers of the abovementioned olefins with one another or with up to 20% by weight, based on (B2), of vinylaromatics, such as styrene and α-methylstyrene, C₁-C₄-alkylstyrene, such as 2-, 3- and 4-methylstyrene and 4-tert-butylstyrene, are also suitable.

Particularly preferred comonomers (B) are oligopropylenes and oligoisobutenes having an average molecular weight Mₙ of from 300 to 5 000, preferably from 400 to 3 000, particularly preferably from 500 to 2 300, very particularly preferably from 550 to 1 000μg/mol, for example determined by means of gel permeation chromatography (GPC). Particularly preferred oligoisobutenes and oligopropylenes are furthermore those which are obtainable by oligomerization of at least 3, preferably at least 4, equivalents of C₂-C₁₀-alkene.

In an embodiment of the present invention, comonomers (B2) have a polydispersity M_{w}/Mₙ of from 1.1 to 3, preferably from 1.5 to 1.8.

Oligopropylenes and oligoisobutenes are known as such, and oligoisobutenes are obtainable, for example, by oligomerization of isobutene in the presence of boron trifluoride catalyst, cf. for example DE-A 27 02 604. Suitable isobutene-containing starting materials are both isobutene itself and isobutene-containing C₄-hydrocarbon streams, for example refined C₄ fractions, C₄ cuts from isobutane dehydrogenation, C₄ cuts from steam crackers or FCC crackers (FCC: fluid catalyzed cracking), provided that relevant C₄ cuts have been substantially freed from 1,3-butadiene contained therein. Typically, the concentration of isobutene in C₄ hydrocarbon streams is from 40 to 60% by weight. Suitable C₄ hydrocarbon streams should as a rule comprise less than 500, preferably less than 200, ppm of 1,3-butadiene.

Oligomers of ethylene are known and are commercially available, for example, as 1-octene, 1-decene, 1-dodecene, 1-tetradecene, 1-hexadecene, 1-octadecene and 1-eicosene.

The preparation of further exemplary oligomers (B2) is known per se; methods are to be found, for example, in WO 96/23751 and in WO 99/67347, example 3.

Of course, copolymer (b) used in the novel process may comprise both a vinylaromatic compound (B1) and an oligomer (B2) in the form of polymerized units.

Copolymer used in the novel process as (b) may comprise, in the form of polymerized units, at least one ethylenically unsaturated comonomer (C) differing from (A) and having at least one hetero atom. Preferably, (C) is selected from
C₃-C₈-carboxylic acid derivatives of the formula VI 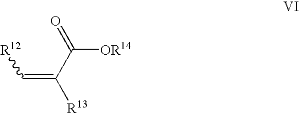
unsaturated amides of the formula VII 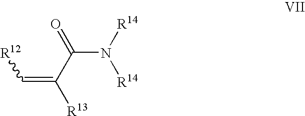
acyclic amides of the formula VIII a and cyclic amides of the formula VIII b 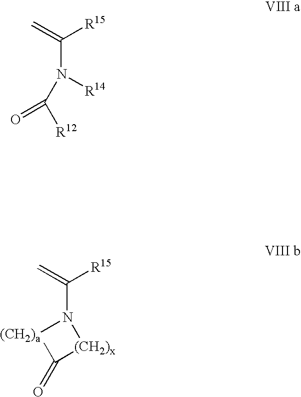
C₁-C₂₀-alkyl vinyl ethers, such as methyl vinyl ether, ethyl vinyl ether, n-propyl vinyl ether, isopropyl vinyl ether, n-butyl vinyl ether, isobutyl vinyl ether, 2-ethylhexyl vinyl ether or n-octadecyl vinyl ether;
olefins, for example isobutene;
N-vinyl derivatives of nitrogen-containing aromatic compounds, preferably N-vinylimidazole, 2-methyl-1-vinylimidazole, N-vinyloxazolidone, N-vinyltriazole, 2-vinylpyridine, 4-vinylpyridine, 4-vinylpyridine N-oxide, N-vinylimidazoline, N-vinyl-2-methylimidazoline;
α,β-unsaturated nitriles, such as acrylonitrile or methacrylonitrile;
alkoxylated unsaturated ethers of the formula IX 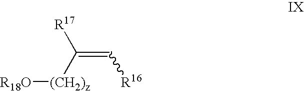
unsaturated esters and amides of the formula X 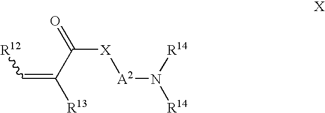
unsaturated esters of the formula XI 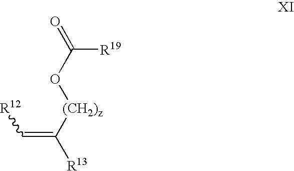
comonomers containing phosphate, phosphonate, sulfate and sulfonate groups, such as [2-{(meth)acryloyloxy}ethyl]phosphate or 2-(meth)acrylamido-2-methyl-1propanesulfonic acid;
where
A¹ and A² are identical or different and are C₂-C₆-alkylene, for example —CH₂—, —CH(CH₃)—, —(CH₂)₂—, —CH₂—CH(CH₃)—, —(CH₂)₃—, —CH₂—CH(C₂H₅)—, —(CH₂)₄—, —(CH₂)₅—, —(CH₂)₆—, preferably C₂-C₄-alkylene, in particular —(CH₂)₂—, —CH₂—CH(CH₃)— and —CH₂—CH(C₂H₅)—;
n is an integer from 1 to 200, preferably from 4 to 25, particularly preferably from 7 to 20.

The groups A¹ may of course be different only when n is a number greater than 1.
R¹² and R¹³ are identical or different and are selected from straight-chain and branched C₁-C₅-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl or isoamyl, particularly preferably C₁-C₄-alkyl, such as methyl, ethyl, n-propyl, isopropyl, n-butyl, isobutyl, sec-butyl or tert-butyl;
   and in particular hydrogen;
R¹⁴ are identical or different and are branched or straight-chain C₁-C₂₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl or n-eicosyl, particularly preferably C₁-C₄-alkyl, such as methyl, ethyl, n-propyl, isopropyl, n-butyl, isobutyl, sec-butyl or tert-butyl;
   or particularly preferably hydrogen;
R¹⁵ is hydrogen or methyl;
x is an integer from 2 to 6, preferably from 3 to 5;
z is an integer selected from 0 and 1, preferably 1;
a is an integer from 0 to 6, preferably from 0 to 2;
R¹⁶ and R¹⁷ are identical or different and are selected from hydrogen, straight-chain and branched C₁-C₁₀-alkyl, C₁-C₁₀-alkyl being defined as above;
X is oxygen or N—R¹⁴;
R¹⁸ is [A¹-O]ₙ—R¹⁴,
R¹⁹ is selected from straight-chain and branched C₁-C₂₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, n-tetradecyl, n-hexadecyl, n-octadecyl or n-eicosyl; preferably C₁-C₁₄-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl or n-tetradecyl;
   and in particular hydrogen or methyl.

The remaining variables are defined as above.

Compounds of the formula VII which are selected by way of example are (meth)acrylamides, such as acrylamide, N-methylacrylamide, N,N-dimethylacrylamide, N-ethylacrylamide, N-propylacrylamide, N-tert-butylacrylamide, N-tert-octylacrylamide, N-undecylacrylamide or the corresponding methacrylamides.

Compounds of the formula VIII a which are selected by way of example are N-vinylcarboxamides, such as N-vinylformamide, N-vinyl-N-methylformamide, N-vinylacetamide or N-vinyl-N-methylacetamide; typical compounds of the formula VIII b which are selected by way of example are N-vinylpyrrolidone, N-vinyl-4-piperidone and N-vinyl-ε-caprolactam.

Compounds of the formula X which are selected by way of example are (meth)acrylates and (meth)acrylamides, such as N,N-dialkylaminoalkyl(meth)acrylates or N,N-dialkylaminoalkyl(meth)acrylamides; examples are N,N-dimethylaminoethyl acrylate, N,N-dimethylaminoethyl methacrylate, N,N-diethylaminoethyl acrylate, N,N-diethylaminoethyl methacrylate, N,N-dimethylaminopropyl acrylate, N,N-dimethylaminopropyl methacrylate, N,N-diethylaminopropyl acrylate, N,N-diethylaminopropyl methacrylate, 2-(N,N-dimethylamino)ethylacrylamide, 2-(N,N-dimethylamino)ethylmethacrylamide, 2-(N,N-diethylamino)ethylacrylamide, 2-(N,N-diethylamino)ethylmethacrylamide, 3-(N,N-dimethylamino)propylacrylamide and 3-(N,N-dimethylamino)propylmethacrylamide.

Compounds of the formula XI which are selected by way of example are vinyl acetate, allyl acetate, vinyl propionate, vinyl butyrate, vinyl 2-ethylhexanoate or vinyl laurate.

Copolymers (b) are obtainable, for example, by free radical copolymerization of (A), (B1) or (B2) and, if appropriate, (C) and reaction with at least one compound (D) of the formula I a or I b 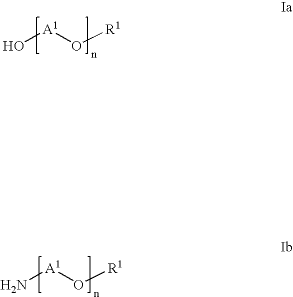
and optionally hydrolysis with water or an aqueous alkaline solution,
where, in formula I a and I b, R¹ is defined as follows:
R¹ is linear or branched C₁-C₂₀-alkyl, such as methyl, ethyl, n-propyl, isopropyl, n-butyl, isobutyl, sec-butyl, tert-butyl, n-pentyl, isopentyl, sec-pentyl, neo-pentyl, 1,2-dimethylpropyl, isoamyl, n-hexyl, isohexyl, sec-hexyl, n-heptyl, n-octyl, n-nonyl, n-decyl, n-dodecyl, n-hexadecyl, n-octadecyl or n-eicosyl; particularly preferably C₁-C₄-alkyl, such as methyl, ethyl, n-propyl, isopropyl, n-butyl, isobutyl, sec-butyl or tert-butyl.

The other variables are defined as above.

Particular examples of compounds of the formula I a are

polyethylene glycols of the formula HO—(CH₂CH₂O)ₘ—CH₃ which are blocked by methyl terminal groups and in which m is from 1 to 200, preferably from 4 to 100, particularly preferably 4-50

block copolymers blocked with methyl terminal groups and comprising ethylene oxide, propylene oxide and/or butylene oxide, having a molecular weight M_{w} of from 300 to 5 000 g/mol

random copolymers blocked with methyl terminal groups and comprising ethylene oxide, propylene oxide and/or butylene oxide, having a molecular weight M_{w} of from 300 to 5 000 g/mol

alkoxylated C₂- to C₃₀-alcohols, in particular fatty alcohol alkoxylates, oxo alcohol alkoxylates or Guerbet alcohol alkoxylates, it being possible for the alkoxylation to be carried out with ethylene oxide, propylene oxide and/or butylene oxide; examples are

C₁₃-C₁₅-oxo alcohol ethoxylates having from 3 to 30 ethylene oxide units,

C₁₃-oxo alcohol ethoxylates having from 3 to 30 ethylene oxide units,

C₁₂-C₁₄-fatty alcohol ethoxylates having from 3 to 30 ethylene oxide units,

C₁₀-oxo alcohol ethoxylates having from 3 to 30 ethylene oxide units,

C₁₀-Guerbet alcohol ethoxylates having from 3 to 30 ethylene oxide units,

C₉-C₁₁-oxo alcohol alkoxylates having from 2 to 20 ethylene oxide units, from 2 to 20 propylene oxide units and/or from 1 to 5 butylene oxide units;

C₁₃-C₁₅-oxo alcohol alkoxylates having from 2 to 20 ethylene oxide units, from 2 to 20 propylene oxide units and/or from 1 to 5 butylene oxide units;

C₄-C₂₀-alcohol ethoxylates having from 2 to 20 ethylene oxide units.

In an embodiment of the present invention, the molar ratio (A):(B1) or (A) to (B2) in copolymer (b) is 1:0.1 to 10, preferably 1:0.2 to 5, particularly preferably 1:0.3 to 3.

In an embodiment of the present invention, the molar ratio (A) to (C) in copolymer (b) is from 1:0 to 1:10, preferably from 10:1 to 1:5, particularly preferably from 5:1 to 1:3.

In an embodiment of the present invention, the molar ratio of (A) to [(B1)+(C)] or (A) to [(B2)+(C)] in copolymer (b) is from 2:1 to 1:20, preferably from 1:1 to 1:10, particularly preferably from 1:1 to 1:6.

The preparation of the copolymers (b) used in the novel process can be carried out by methods known per se. Thus, it is possible to copolymerize the monomers (A), (B1) or (B2) and, if appropriate, (C) with one another by solution polymerization, precipitation polymerization or in the absence of a solvent by mass polymerization and then to react the product with (D). (A), (B1) or (B2) and, if appropriate, (C) may copolymerize in the form of random copolymers, as alternating copolymers or as block copolymers.

Pressure and temperature conditions for the copolymerization of (A), (B1) or (B2) and, if appropriate, (C) are in general not critical. The temperatures are, for example, from 40 to 200° C., preferably from 60 to 150° C., and the pressure is, for example, from 1 to 10, preferably from 1 to 3, bar.

Suitable solvents are those solvents which are considered to be inert to anhydrides of dicarboxylic acid of 4 to 8 carbon atoms, in particular acetone, tetrahydrofuran or 1,4-dioxane. Suitable precipitating agents are aromatic and aliphatic hydrocarbons, for example toluene, ortho-xylene, meta-xylene, para-xylene, ethylbenzene or mixtures of one or more of the abovementioned aromatic hydrocarbons, n-hexane, petroleum ether or isododecane. Mixtures of aromatic and aliphatic hydrocarbons are also suitable.

It is possible to use regulators, for example mercaptoethanol or n-dodecyl mercaptan. Suitable amounts are, for example, from 0.1 to 6% by weight, based on the mass of all comonomers.

The copolymerization is advantageously initiated by means of initiators, for example peroxides or hydroperoxides. Examples of peroxides or hydroperoxides are di-tert-butyl peroxide, tert-butyl peroctanoate, tert-butyl perpivalate, tert-butyl per-2-ethylhexanoate, tert-butyl permaleate, tert-butyl perisobutyrate, benzoyl peroxide, diacetyl peroxide, succinyl peroxide, p-chlorobenzoyl peroxide and dicyclohexyl peroxodicarbonate. The use of redox initiators is also suitable, and additionally azo compounds, such as 2,2′-azobisisobutyronitrile, 2,2′-azobis(2-methylpropionamidine)dihydrochloride and 2,2′-azobis(4-methoxy-2,4-dimethylvaleronitrile). In general, these initiators are used in amounts of from 0.1 to 20, preferably from 0.2 to 15, % by weight, based on the mass of all monomers.

The copolymerization described above gives copolymers. The copolymers obtained can be subjected to a purification by conventional methods, for example reprecipitation or extractive removal of unconverted monomers. If a solvent or precipitating agent was used, it is possible to remove it after the end of the copolymerization, for example by distilling off.

In an embodiment of the present invention, the copolymers obtained are not subjected to any additional purification and are reacted immediately with (D).

In a further embodiment of the present invention, the copolymerization is carried out in the presence of the total amount or a proportion of the compound (D) to be used. In this embodiment, it is possible partly or completely to dispense with the use of solvents [symbol] cipitating agents. The removal of any solvents or precipitating agents used is [symbol] re simple or is entirely dispensed with.

[symbol] action of the copolymers described above with (D) is effected, for example, at [symbol] 0 to 150° C.

[symbol] action of the copolymers described above with (D) is effected, for example, at [symbol] 1 to 10, preferably from 1 to 3, bar.

[symbol] mount of (D) can be calculated so that complete conversion (D) is assumed and, [symbol] ample, from 5 to 80, preferably from 10 to 67, particularly preferably from [symbol] ol %, based on (A), of (D) are used.

[symbol] luration of the reaction of the copolymers described above with (D) is in general [symbol] 0.5 to 8, preferably from 1 to 5, hours.

[symbol] eaction of the copolymers described above with (D) can be carried out in the [symbol] ce or in the presence of catalysts, in particular acidic catalysts, e.g. sulfuric acid, [symbol] anesulfonic acid, p-toluenesulfonic acid, n-dodecylbenzenesulfonic acid, [symbol] chloric acid or acidic ion exchangers.

[symbol] urther variant of the process described, the reaction of the copolymers described [symbol] e with (D) is carried out in the presence of an entraining agent which forms an [symbol] trope with the water formed if appropriate in the reaction.

[symbol] neral, under the conditions of the steps described above, (D) reacts completely or [symbol] ertain percentage with the carboxyl groups of the anhydrides (A) and if [symbol] priate with the carboxyl groups from (C). In general, less than 40 mol % remain [symbol] d as unconverted (D).

[symbol] ossible to separate unconverted (D) from the copolymer (b) used in the novel [symbol] ess by methods known per se, for example extraction.

[symbol] embodiment of the present invention, the further step of separating unreacted (D) [symbol] copolymer (b) used in the novel process can be dispensed with. In this [symbol] odiment, copolymer (b) is used together with a certain percentage of unreacted (D) [symbol] e production of leather or semifinished products.

[symbol] embodiment of the present invention, further initiator can be added to copolymer [symbol] fter the hydrolysis, and deodorized copolymer (b), which can be used for the [symbol] uction of leather or semifinished products, is obtained.

Ivents

In a further embodiment, copolymer (b) is reacted with water or with an aqueous alkaline solution, and partially or completely hydrolyzed copolymers, which in the context of the present invention are likewise comprised under (b), are obtained.

If it is desired to treat, according to the invention, pelts, pickled pelts or semifinished products with

(a) at least one sheet silicate and

(b) at least one copolymer which is obtainable as described above,

it is possible to carry out two separate treatment steps and to treat pelts, pickled pelts or semifinished products first with at least one sheet silicate (a) and, later on, for example during the retanning, with at least one copolymer (b). It is also possible to treat pelts, pickled pelts or semifinished products first with at least one copolymer (b) and later on, for example during the pretanning, with at least one sheet silicate (a).

In an embodiment of the present invention, pelts, pickled pelts or semifinished products are treated in a single operation for example during the pretanning, during the tanning or during the retanning, with at least one sheet silicate (a) and with at least one copolymer (b).

In a special embodiment of the present invention, the novel treatment with at least one sheet silicate (a) and with at least one copolymer (b) can be carried out repeatedly.

In an embodiment of the present invention, pelts, pickled pelts or semifinished products are additionally treated with

(c) at least one substance which is selected from

dicarbonyl compounds of the formula II 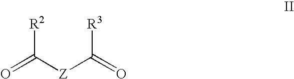
and substances which liberate the dicarbonyl compound of the formula II in the presence of water, the variables being defined as follows:
R² and R³ are identical or different and are selected from
   hydrogen;
C₁-C₁₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, and n-dodecyl; preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl, such as methyl, ethyl, n-propyl, isopropyl, n-butyl, isobutyl, sec-butyl and tert-butyl, very particularly preferably methyl;
C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl and cyclododecyl, preferably cyclopentyl, cyclohexyl and cycloheptyl;
   examples of substituted cycloalkyl radicals are: 2-methylcyclopentyl, 3-methylcyclopentyl, cis-2,4-dimethylcyclopentyl, trans-2,4-dimethylcyclopentyl, 2,2,4,4-tetramethylcyclopentyl, 2-methylcyclohexyl, 3-methylcyclohexyl, 4 methylcyclohexyl, cis-2,5-dimethylcyclohexyl, trans-2,5-dimethylcyclohexyl, 2,2,5,5-tetramethylcyclohexyl, 2-methoxycyclopentyl, 2-methoxycyclohexyl, 3-methoxycyclopentyl, 3-methoxycyclohexyl, 2-chlorocyclopentyl, 3-chlorocyclopentyl, 2,4-dichlorocyclopentyl, 2,2,4,4-tetrachlorocyclopentyl, 2-chlorocyclohexyl, 3-chlorocyclohexyl, 4-chlorocyclohexyl, 2,5-dichlorocyclohexyl, 2,2,5,5-tetrachlorocyclohexyl, 2-thiomethylcyclopentyl, 2-thiomethylcyclohexyl, 3-thiomethylcyclopentyl, 3-thiomethylcyclohexyl and further derivatives;
C₇-C₁₃-aralkyl, preferably C₇- to C₁₂-phenylalkyl, such as benzyl, 1-phenethyl, 2-phenethyl, 1-phenylpropyl, 2-phenylpropyl, 3-phenylpropyl, neophyl (1-methyl-1-phenylethyl), 1-phenylbutyl, 2-phenylbutyl, 3-phenylbutyl and 4-phenylbutyl, particularly preferably benzyl,
C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl, unsubstituted or substituted by one or more
   C₁-C₁₂-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl and n-dodecyl, preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl and sec-hexyl, particularly preferably C₁-C₄-alkyl, such as methyl, ethyl, n-propyl, isopropyl, n-butyl, isobutyl, sec-butyl and tert-butyl;
   halogens, such as fluorine, chlorine, bromine and iodine, chlorine and bromine being preferred;
   C₁-C₁₂-alkoxy groups, preferably C₁-C₆-alkoxy groups, such as methoxy, ethoxy, n-propoxy, isopropoxy, n-butoxy, isobutoxy, sec-butoxy, tert-butoxy, n-pentyloxy, isopentyloxy, n-hexyloxy and isohexyloxy, particularly preferably methoxy, ethoxy, n-propoxy and n-butoxy.
   Neighboring substituents may be linked to one another with formation of a ring.

In a particular embodiment, R² and R³ are covalently bonded to one another with formation of a 4- to 13-membered ring. Thus, R² and R³ together may be, for example, C₃-C₈-alkylene, unsubstituted or substituted by, for example, C₁-C₁₂-alkyl or C₆-C₁₄-aryl. Examples are: —(CH₂)₃—, —(CH₂)₂—CH(CH₃)—, —(CH₂)₂—CH(C₂H₅)—, —(CH₂)₂—CH(C₆H₅)—, —(CH₂)₄—, —(CH₂)₅—, —(CH₂)₆, —(CH₂)₇—, —CH(CH₃)—CH₂—CH₂—CH(CH₃)—, —CH(CH₃)—CH₂—CH₂—CH₂—CH(CH₃)—, preferably C₃-C₅-alkylene, such as —(CH₂)₃—, —(CH₂)₄—, —(CH₂)₅—.

R² and R³ are each very particularly preferably hydrogen.

Z is selected from

a single bond and

bivalent organic groups, which in turn are selected from

optionally substituted C₁-C₁₂-alkylene, such as —CH₂—, —CH₂—CH₂—, —(CH₂)₃—, —(CH₂)₄—, —(CH₂)₅—, —(CH₂)₆—, —(CH₂)₇—, —(CH₂)₈—, —(CH₂)₉—, —(CH₂)₁₀—, —(CH₂)₁₁—, —(CH₂)₁₂—, cis- or trans-CH═CH—, Z- or E-CH₂—CH═CH—; preferably —CH₂—, —CH₂—CH₂—, —(CH₂)₃—, —(CH₂)₄—, —CH(CH₃)—, —CH(C₆H₅)—, —CH(CH₃)—CH₂—, syn-CH(CH₃)—CH(CH₃)—, anti-CH(CH₃)—CH(CH₃)—, syn-CH(CH₃)—CH(C₆H₅)—, anti-CH(CH₃)—CH(C₆H₆)—, —{CH(CH₃)}₃—;

optionally substituted C₅-C₁₂-cycloalkylene, such as trans- or cis-1,2-cyclopentanylene, trans- or cis-1,3-cyclopentanylene, trans- or cis-1,3-cyclopent-4-enylene, trans- or cis-1,4-cyclohexanylene, trans- or cis-1,4- cyclohex-2-enylene, trans- or cis-1,3-cyclohexanylene, trans- or cis-1,2-cyclohexanylene, optionally substituted by one or more C₁-C₄-alkyl groups, such as methyl, ethyl, n-propyl, isopropyl, n-butyl, sec-butyl, isobutyl or tert-butyl, or one or more halogen atoms, such as fluorine, chlorine., bromine or iodine, or

optionally substituted C₆-C₁₄-arylene, such as para-phenylene, meta-phenylene, ortho-phenylene, 1,2-naphthylene, 1,3-naphthylene, 1,4-naphthylene, 1,5-naphthylene, 1,6-naphthylene, 1,7-naphthylene, 1,8-naphthylene, 2,3-naphthylene, 2,7-naphthylene, 2,6-naphthylene, 1,4-anthrylene, 9,10-anthrylene, p,p′-biphenylene, optionally substituted by one or more C₁-C₄-alkyl groups, such as methyl, ethyl, n-propyl, isopropyl, n-butyl, sec-butyl, isobutyl or tert-butyl, or one or more halogen atoms, such as fluorine, chlorine, bromine or iodine.

In an embodiment of the present invention, Z is 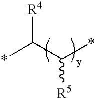
where
R⁴ is selected from hydrogen;
C₁-C₁₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl and n-dodecyl; preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl, such as methyl, ethyl, n-propyl, isopropyl, n-butyl, isobutyl, sec-butyl and tert-butyl, very particularly preferably methyl;
C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl and cyclododecyl, preferably cyclopentyl, cyclohexyl and cycloheptyl;
   examples of substituted cycloalkyl radicals are: 2-methylcyclopentyl, 3-methylcyclopentyl, cis-2,4-dimethylcyclopentyl, trans-2,4-dimethylcyclopentyl, 2,2,4,4-tetramethylcyclopentyl, 2-methylcyclohexyl, 3-methylcyclohexyl, 4-methylcyclohexyl, cis-2,5-dimethylcyclohexyl, trans-2,5-dimethylcyclohexyl, 2,2,5,5-tetramethylcyclohexyl, 2-methoxycyclopentyl, 2-methoxycyclohexyl, 3-methoxycyclopentyl, 3-methoxycyclohexyl, 2-chlorocyclopentyl, 3-chlorocyclopentyl, 2,4-dichlorocyclopentyl, 2,2,4,4-tetrachlorocyclopentyl, 2-chlorocyclohexyl, 3-chlorocyclohexyl, 4-chlorocyclohexyl, 2,5-dichlorocyclohexyl, 2,2,5,5-tetrachlorocyclohexyl, 2-thiomethylcyclopentyl, 2-thiomethylcyclohexyl, 3-thiomethylcyclopentyl, 3-thiomethylcyclohexyl and further derivatives;
C₇-C₁₃-aralkyl, preferably C₇- to C₁₂-phenylalkyl, such as benzyl, 1-phenethyl, 2-phenethyl, 1-phenylpropyl, 2-phenylpropyl, 3-phenylpropyl, neophyl(1-methyl-1-phenylethyl), 1-phenylbutyl, 2-phenylbutyl, 3-phenylbutyl and 4-phenylbutyl, particularly preferably benzyl;
C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl, unsubstituted or substituted by one or more
   C₁-C₁₂-alkyl groups which are defined as above,
   halogens which are defined as above,
   C₁-C₁₂-alkoxy groups which are defined as above;
   y is an integer from 1 to 4, preferably 2 or 3, very particularly preferably 3;
   R⁵ are identical or different and are selected from hydrogen, C₁-C₁₂-alkyl, C₃-C₁₂-cycloalkyl, substituted or unsubstituted, C₇-C₁₃-aralkyl, C₆-C₁₄-aryl, substituted or unsubstituted.

R⁴ may be linked to neighboring R⁵ or, where y<1, in each case two neighboring radicals R⁵ may be linked to one another with formation of a ring.

Instead of using the dicarbonyl compound of the formula II as such, in a preferred embodiment of the present invention it is possible to use substances which liberate a carbonyl compound of the formula II in the presence of water.

Examples of substances which liberate a dicarbonyl compound of the formula II in the presence of water are hydrates, hemihydrates, acetals, hemiacetals or ketals and hemiketals of dicarbonyl compounds of the formula II with alcohols, such as C₁-C₁₂-alkanols, preferably methanol or ethanol, and furthermore aldols.

In an embodiment of the present invention, the chosen substance which liberates a dicarbonyl compound of the formula II in the presence of water is a substance which is obtainable by reacting at least one carbonyl compound of the formula III 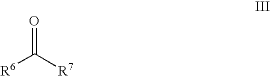
with at least one dicarbonyl compound of the formula II,
where
R⁶ and R⁷ are identical or different and are selected from hydrogen;
C₁-C₁₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl and n-dodecyl, preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl and sec-hexyl, particularly preferably C₁-C₄-alkyl, such as methyl, ethyl, n-propyl, isopropyl, n-butyl, isobutyl, sec-butyl and tert-butyl, very particularly preferably methyl;
C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl and cyclododecyl, preferably cyclopentyl, cyclohexyl and cycloheptyl;
   examples of substituted cycloalkyl radicals are: 2-methylcyclopentyl, 3-methylcyclopentyl, cis-2,4-dimethylcyclopentyl, trans-2,4-dimethylcyclopentyl, 2,2,4,4-tetramethylcyclopentyl, 2-methylcyclohexyl, 3-methylcyclohexyl, 4-methylcyclohexyl, cis-2,5-dimethylcyclohexyl, trans-2,5-dimethylcyclohexyl, 2,2,5,5-tetramethylcyclohexyl, 2-methoxycyclopentyl, 2-methoxycyclohexyl, 3-methoxycyclopentyl, 3-methoxycyclohexyl, 2-chlorocyclopentyl, 3-chlorocyclopentyl, 2,4-dichlorocyclopentyl, 2,2,4,4-tetrachlorocyclopentyl, 2-chlorocyclohexyl, 3-chlorocyclohexyl, 4-chlorocyclohexyl, 2,5-dichlorocyclohexyl, 2,2,5,5-tetrachlorocyclohexyl, 2-thiomethylcyclopentyl, 2-thiomethylcyclohexyl, 3-thiomethylcyclopentyl, 3-thiomethylcyclohexyl and further derivatives;
C₇-C₁₃-aralkyl, preferably C₇- to C₁₂-phenylalkyl, such as benzyl, 1-phenethyl, 2-phenethyl, 1-phenylpropyl, 2-phenylpropyl, 3-phenylpropyl, neophyl (1-methyl-1-phenylethyl), 1-phenylbutyl, 2-phenylbutyl, 3-phenylbutyl and 4-phenylbutyl, particularly preferably benzyl;
C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl, unsubstituted or substituted by one or more
   C₁-C₁₂-alkyl groups which are defined as above,
   halogens which are defined as above,
   C₁-C₁₂-alkoxy groups which are defined as above.

In a preferred embodiment, the carbonyl compound of the formula III or dicarbonyl compound of the formula II has at least one hydrogen atom in the α-position relative to the respective carbonyl function.

In an embodiment of the present invention, R⁶ and R⁷ may be linked to one another with formation of a ring. Thus, R⁶ and R⁷ together may be, for example, C₁-C₈-alkylene, unsubstituted or substituted by, for example, C₁-C₁₂-alkyl or C₆-C₁₄-aryl. Examples are: —CH₂—, —CH(CH₃)—, —(CH₂)₂—, —CH₂—CH(CH₃)—, —CH₂—CH(C₂H₅)—, —(CH₂)₃—, —(CH₂)₂—CH(CH₃)—, —(CH₂)₂—CH(C₂H₅)—, —(CH₂)₂—CH(C₆H₅)—, —(CH₂)₄—, —(CH₂)₅—, —(CH₂)₆—, —(CH₂)₇—, —CH(CH₃)—CH₂—CH₂—CH(CH₃)—, —CH(CH₃)—CH₂—CH₂—CH₂—CH(CH₃)—, preferably C₃-C₅-alkylene, such as —(CH₂)₃—, —(CH₂)₄—, —(CH₂)₅—.

In another embodiment of the present invention, the chosen substance which liberates a dicarbonyl compound of the formula II in the presence of water is a substance which is obtainable by reacting at least one carbonyl compound of the formula III with at least one cyclic compound of the formula IV a or IV b 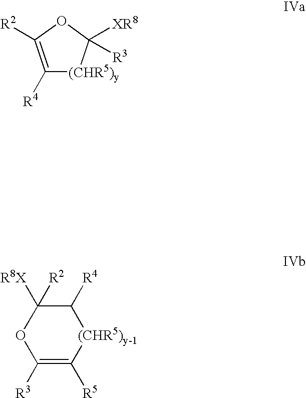
where
X is selected from oxygen, sulfur and N—R⁸, in particular oxygen;
X is selected from oxygen, sulfur and N—R⁸, oxygen being preferred;
R⁸ are different or preferably identical and are selected from hydrogen;
C₁-C₁₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl and n-dodecyl; preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl, such as methyl, ethyl, n-propyl, isopropyl, n-butyl, isobutyl, sec-butyl and tert-butyl, very particularly preferably methyl;
C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl and cyclododecyl, preferably cyclopentyl, cyclohexyl and cycloheptyl;
   examples of substituted cycloalkyl groups are: 2-methylcyclopentyl, 3-methylcyclopentyl, cis-2,4-dimethylcyclopentyl, trans-2,4-dimethylcyclopentyl, 2,2,4,4-tetramethylcyclopentyl, 2-methylcyclohexyl, 3-methylcyclohexyl, 4-methylcyclohexyl, cis-2,5-dimethylcyclohexyl, trans-2,5-dimethylcyclohexyl, 2,2,5,5-tetramethylcyclohexyl, 2-methoxycyclopentyl, 2-methoxycyclohexyl, 3-methoxycyclopentyl, 3-methoxycyclohexyl, 2-chlorocyclopentyl, 3-chlorocyclopentyl, 2,4-dichlorocyclopentyl, 2,2,4,4-tetrachlorocyclopentyl, 2-chlorocyclohexyl, 3-chlorocyclohexyl, 4-chlorocyclohexyl, 2,5-dichlorocyclohexyl, 2,2,5,5-tetrachlorocyclohexyl, 2-thiomethylcyclopentyl, 2-thiomethylcyclohexyl, 3-thiomethylcyclopentyl, 3-thiomethylcyclohexyl;
C₇-C₁₃-aralkyl, preferably C₇- to C₁₂-phenylalkyl, such as benzyl, 1-phenethyl, 2-phenethyl, 1-phenylpropyl, 2-phenylpropyl, 3-phenylpropyl, neophyl (1-methyl-1-phenylethyl), 1-phenylbutyl, 2-phenylbutyl, 3-phenylbutyl and 4-phenylbutyl, particularly preferably benzyl;
C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl, unsubstituted
   or substituted C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenantryl, preferably phenyl, 1-naphthyl and 2-naphthyl, particularly preferably phenyl, substituted by one or more
   C₁-C₁₂-alkyl groups which are defined as above,
   halogens which are defined as above,
   C₁-C₁₂-alkoxy groups which are defined as above;
      formyl,
CO—C₁-C₁₂-alkyl, such as acetyl, propionyl, n-butyryl, isobutyryl, sec-butyryl, tert-butyryl, n-valeroyl, isovaleroyl, sec-valeroyl, n-capryl, n-dodecanoyl; preferably CO—C₁-C₄-alkyl, such as acetyl, propionyl, n-butyryl, isobutyryl, sec-butyryl, tert-butyryl, very particularly preferably acetyl;
CO—C₃-C₁₂-cycloalkyl, such as cyclopropylcarbonyl, cyclobutylcarbonyl, cyclopentylcarbonyl, cyclohexylcarbonyl, cycloheptylcarbonyl, cyclooctylcarbonyl, cyclononylcarbonyl, cyclodecylcarbonyl, cycloundecylcarbonyl and cyclododecylcarbonyl, preferably cyclopentylcarbonyl, cyclohexylcarbonyl and cycloheptylcarbonyl;
   examples of substituted cycloalkyl groups are: 2-methyl-cyclopentylcarbonyl, 3-methylcyclopentylcarbonyl, 2-methylcyclohexylcarbonyl, 3-methylcyclohexylcarbonyl, 4-methylcyclohexylcarbonyl, cis-2,5-dimethylcyclohexylcarbonyl, trans-2,5-dimethylcyclohexylcarbonyl, 2-methoxycyclopentylcarbonyl, 2-methoxycyclohexylcarbonyl, 3-methoxy-cyclopentylcarbonyl, 3-methoxycyclohexylcarbonyl, 2-chlorocyclopentylcarbonyl, 3-chlorocyclopentylcarbonyl, 2,4-dichlorocyclopentylcarbonyl, 2-chlorocyclohexylcarbonyl, 3-chlorocyclohexylcarbonyl, 4-chlorocyclohexylcarbonyl, 2,5-dichlorocyclohexylcarbonyl, 2-thiomethylcyclopentylcarbonyl, 2-thiomethylcyclohexylcarbonyl, 3-thiomethylcyclopentylcarbonyl, 3-thiomethylcyclohexyl;
CO—C₇-C₁₃-aralkyl, preferably CO—C₇-C₁₂-phenylalkyl, such as phenylacetyl and ω-phenylpropionyl, particularly preferably phenylacetyl,
CO—C₆-C₁₄-aryl, for example benzoyl, 1-naphthoyl, 2-naphthoyl, 1-anthroyl, 2-anthroyl, 9-anthroyl, 1-phenanthroyl, 2-phenanthroyl, 3-phenanthroyl, 4-phenanthroyl and 9-phenanthroyl, preferably benzoyl, 1-naphthoyl and 2-naphthoyl, particularly preferably benzoyl.

R² and R⁸ may be linked to one another with formation of a ring. Where X is N—R⁸, two radicals R⁸ may be linked to one another with the formation of a ring. For example, R⁸ and R² or R⁸ and R⁵ or two radicals R⁸ together may be, for example, C₁-C₈-alkylene, unsubstituted or substituted by, for example, C₁-C₁₂-alkyl or C₆-C₁₄-aryl. Examples are: —CH₂—, —CH(CH₃)—, —(CH₂)₂—, —CH₂—CH(CH₃)—, —CH₂—CH(C₂H₅)—, —(CH₂)₃—, —(CH₂)₂—CH(CH₃)—, —(CH₂)₂—CH(C₂H₅)—, —(CH₂)₂—CH(C₆H₅)—, —(CH₂)₄—, —(CH₂)₅—, —(CH₂)₆—, —(CH₂)₇—, —CH(CH₃)—CH₂—CH₂—CH(CH₃)—, —CH(CH₃)—CH₂—CH₂—CH₂—CH(CH₃)—, preferably C₃-C₅-alkylene, such as —(CH₂)₃—, —(CH₂)₄—, —(CH₂)₅—;
y is an integer from 1 to 4, in particular 2 or 3;
   the remaining variables are defined as above.

In a preferred embodiment of the present invention, R⁴ and R⁵ and R⁸ are each methyl, and y is 3.

In a particularly preferred embodiment of the present invention, 2-methoxy-2,3-dihydro-4H-pyran (formula IV b.1) 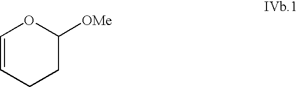
where Me is CH₃
is chosen as the compound of the formula IV b.

Very particularly preferred carbonyl compounds of the formula III are methyl ethyl ketone, formaldehyde and in particular acetone.

Substances which are used according to the invention and which liberate a dicarbonyl compound of the formula II in the presence of water may be present in monomeric or dimeric form.

Substances which are used according to the invention and which liberate a dicarbonyl compound of the formula II in the presence of water and are obtainable by reacting at least one carbonyl compound of the formula III with at least one carbonyl compound of the formula II or with at least one cyclic compound of the formula IV a or IV b are also referred to below as adducts used according to the invention.

Adducts used according to the invention may be present in oligomeric or polymeric form.

Usually, adducts used according to the invention are present as a mixture of dimers, oligomers and polymers, it being possible for the mixtures furthermore to comprise compounds of the formula H—X—R⁸ as a result of the preparation. Adducts used according to the invention may also be present as a mixture with impurities resulting from storage, for example dehydration products, oxidation products, hydrolysis products, crosslinked products or products of one or more retroaldol reactions. Below, the term adducts used comprises not only the pure adducts but also adducts as a mixture with impurities resulting from the preparation and/or resulting from storage.

Adducts used according to the invention can be prepared by reacting at least one carbonyl compound of the formula III with at least one carbonyl compound of the formula II or with at least one cyclic compound of the formula IV a or IV b.

For this purpose, at least one carbonyl compound of the formula II or at least one cyclic compound of the formula IV a or IV b is reacted with at least one carbonyl compound of the formula III, the carbonyl compound of the formula III being used in an excess of up to 1 000, preferably up to 500, particularly preferably up to 200, mol %.

The reaction is preferably effected at from 0 to 120° C., in particular from 20 to 85° C. The reaction can be carried out at any desired pressures from 0.1 to 100 bar, preferably at atmospheric pressure. The reaction can be effected in the presence of a solvent, for example water, toluene, petroleum ether or n-heptane, but the addition of solvents is not necessary. Particularly where the carbonyl compound of the formula III is liquid under the reaction conditions, the use of solvents in the reaction is not necessary.

Some or all of the water formed during the reaction can be distilled off, together with H—X—R⁸ formed in the course of the reaction.

The reaction can be carried out at acidic pH, i.e. for example at a pH of from 0.5 to 6.8, preferably from 0.7 to 4. One or more acidic catalysts are preferably used.

Suitable acidic catalysts are, for example, phosphoric acid, in particular orthophosphoric acid, formic acid, acetic acid, acidic silica gels, acidic alumina, dilute sulfuric acid, sulfonic acids, such as methanesulfonic acid or para-toluenesulfonic acid. If nonaqueous solvents are employed, the use of P₂O₅ or a molecular sieve is conceivable. From 0.1 to 20% by weight, based on carbonyl compound I, of a catalyst may be used.

From 10 minutes to 24 hours are expedient as the reaction time for the formation of the adducts used according to the invention, preferably from one to three hours.

After the reaction, it is possible to work up the reaction mixtures formed during the reaction. Thus, some or all of any solvents used can be removed, for example by distillation, e.g. under reduced pressure. For example, any acidic catalysts used can be neutralized, for example with aqueous alkaline solution, such as sodium hydroxide solution or potassium hydroxide solution. It is also possible to separate off unconverted starting materials, such as excess carbonyl compound of the formula III. Particularly where the carbonyl compound of the formula III is readily volatile, for example acetone or methyl ethyl ketone, it is advantageous to separate off carbonyl compounds of the formula III by distillation.

In some cases, the formation of a multiphase mixture is observed during the reaction. In said cases, it is possible to remove the respective aqueous phase by, for example, decanting or other methods known per se.

In the reaction under the conditions described above, byproducts and secondary products usually form as a result of the preparation, for example by elimination (dehydration), incomplete reactions to oxidation or intramolecular crosslinking. During the storage of an adduct used according to the invention, byproducts resulting from the storage may furthermore occur, for example due to elimination of water (dehydration), oxidations or dimerization, oligomerization or polymerization and crosslinking.

If, in addition to the treatment with at least one sheet silicate (a) and at least one copolymer (b), it is desired to treat pelts, pickled pelts or semifinished products with at least one dicarbonyl compound of the formula II or with an adduct (c) used according to the invention, (c) can be used, for example, in the pretanning, tanning or retanning.

If it is desired to treat, according to the invention, pelts, pickled pelts or semifinished products with
(a) at least one sheet silicate,
(b) at least one copolymer which is obtainable as described above, and
(c) at least one dicarbonyl compound of the formula II or with an adduct used according to the invention,
   it is possible to carry out two or even three separate treatment steps. For example, it is possible to treat pelts or pickled pelts first, for example as or during the pretanning, with at least one sheet silicate (a) and at least one dicarbonyl compound of the formula II or an adduct (c) used according to the invention and later on, for example during the retanning, with at least one copolymer (b). It is also possible to treat pelts or pickled pelts first, for example as or during the pretanning, with at least one copolymer (b) and later on, for example during the retanning, with at least one sheet silicate (a) and at least one dicarbonyl compound of the formula II or an adduct (c) used according to the invention.

It is also possible to treat pelts or pickled pelts first, for example as or during the pretanning, with at least one sheet silicate (a) and at least one copolymer (b) and later on, for example during the retanning, with at least one dicarbonyl compound of the formula II or an adduct (c) used according to the invention. It is also possible to treat pelts or pickled pelts first, for example as or during the pretanning, with at least one dicarbonyl compound of the formula II or an adduct (c) used according to the invention and later on, for example during the retanning, with at least one sheet silicate (a) and at least one copolymer (b).

It is also possible to treat pelts or pickled pelts first, for example as or during the pretanning, with at least one dicarbonyl compound of the formula II or an adduct (c) used according to the invention and at least one copolymer (b) and later on, for example during the retanning, with at least one sheet silicate (a). It is also possible to treat pelts or pickled pelts first, for example as or during the pretanning, with at least one sheet silicate (a) and later on, for example during the retanning, with at least one dicarbonyl compound of the formula II or an adduct (c) used according to the invention and at least one copolymer (b).

In an embodiment of the present invention, pelts, pickled pelts or semifinished products are treated in a single operation, for example only during the pretanning, only during the tanning or only during the retanning, with at least one sheet silicate (a) and with at least one copolymer (b) and with at least one dicarbonyl compound of the formula II or an adduct (c) used according to the invention.

In a special embodiment of the present invention, the novel treatment with at least one sheet silicate (a) and with at least one copolymer (b) and with at least one dicarbonyl compound of the formula II or an adduct (c) used according to the invention can be carried out repeatedly.

In an embodiment of the present invention, pelts, pickled pelts or semifinished products are treated—if appropriate in a plurality of steps—with
(a) from 0.02 to 4, preferably from 0.1 to 1, % by weight of sheet silicate,
(b) from 0.1 to 30, preferably from 0.5 to 10, % by weight of copolymer and
(c) from 0 to 15, preferably from 0.5 to 5, % by weight of at least one dicarbonyl compound of the formula II or adduct used according to the invention,
   the percentages by weight in each case being based on the pelt weight.

In an embodiment of the present invention, the weight ratio of
(a) sheet silicate to
(b) copolymer to
(c) at least one dicarbonyl compound of the formula II or adduct used according to the invention
   is 1 to 1 to 0, preferably 1 to 1 to 0, particularly preferably 0.2 to 1 to 0.5.

If it is desired to carry out the novel treatment of pelts, pickled pelts or semifinished products with at least one sheet silicate (a) and with at least one copolymer (b) and, if appropriate, with at least one dicarbonyl compound of the formula II or an adduct (c) used according to the invention in the pretanning or in the tanning, it is possible to employ, preferably, a pH of from 2.5 to 4, it frequently being observed that the pH increases by about 0.3 to three units while the novel treatment is being carried out. The pH can also be increased by about 0.3 to three units by adding basifying compositions.

The novel treatment of pelts or pickled pelts in the pretanning or in the tanning with at least one sheet silicate (a) and with at least one copolymer (b) and, if appropriate, at least one dicarbonyl compound of the formula II or an adduct (c) used according to the invention can generally be carried out at from 10 to 45° C., preferably from 20 to 30° C. A duration of from 10 minutes to 12 hours, preferably from one to 3 hours, has proven useful. The novel treatment can be carried out in any desired vessel customary in the tannery, for example by drumming in barrels or in rotatable drums having internals.

In a variant of the novel treatment, at least one sheet silicate (a) and at least one copolymer (b) and, if appropriate, one or more carbonyl compounds of the formula II or adducts (c) used according to the invention are added in one portion or in a plurality of portions before or during the pretanning, in a particular variant in the pickle itself.

In a further variant of the novel process, at least one sheet silicate (a) and at least one copolymer (b) and, if appropriate, at least one dicarbonyl compound of the formula II or an adduct (c) used according to the invention are added in one or more portions, before or during a retanning step, for the treatment of pelts, pickled pelts or semifinished products. This variant is also referred to below as novel retanning process.

The novel retanning process can be carried out under otherwise conventional conditions. One or more, for example from 2 to 6, soaking steps are expediently chosen, and washing with water can be effected between the soaking steps. The temperature during the individual soaking steps is in each case from 5 to 60° C., preferably from 20 to 45° C. Further compositions usually used during the retanning, for example fatliquors, leather dyes or emulsifiers, can be employed.

If it is desired to distribute the novel treatment over different steps, for example by treating with at least one sheet silicate (a) in the pretanning and with at least one copolymer (b) and, if appropriate, a dicarbonyl compound of the formula II or an adduct (c) used according to the invention in the main tanning, it is possible to employ conditions otherwise customary in the tannery and merely to use, as an additional reagent, sheet silicate (a), copolymer (b) and, if appropriate, dicarbonyl compound of the formula II or adduct (c) used according to the invention in the individual steps, if appropriate with reduction of the amount of conventional tanning agents or with omission of conventional tanning agents.

In an embodiment of the present invention, pelts, pickled pelts or semifinished products are treated with at least one sheet silicate (a) and with at least one copolymer (b) and, [symbol] opriate, with at least one dicarbonyl compound of the formula II or an adduct (c) [symbol] according to the invention, if appropriate one or more operations customary in the [symbol] y are carried out, for example retanning or complete tanning with one or more [symbol] ium-containing or preferably chromium-free retanning agents, acidification, [symbol] nation with, for example, sodium bicarbonate, washing and partial drying, and [symbol] is then effected, for example in the air or in a drying apparatus, to a residual [symbol] content of from 5 to not more than 40% by weight or less, preferably not more [symbol] % by weight. The residual water content can be determined using moisture [symbol] s, for example the moisture meter Aqua-Boy® LMIII from Schröder [symbol] aschinen KG, Weinheim, and is based on the total weight of the leather or [symbol] inished product. Suitable drying apparatuses can be operated, for example, at [symbol] 10 to 90° C., preferably from 30 to 70° C., for carrying out the novel drying. Suitable [symbol] apparatuses can be operated at atmospheric or reduced pressure, for example [symbol] 1 to 400, preferably from 10 to 100, mbar. It is also possible to carry out the [symbol] drying in an air stream, preferably in a heated air stream.

[symbol] embodiment of the present invention, drying apparatuses for carrying out the [symbol] drying are operated at from 40 to 70° C. and from 10 to 100 mbar.

[symbol] ples of suitable drying apparatuses are drying ovens, vacuum drying ovens and [symbol] m dryers.

[symbol] embodiment of the present invention, the novel drying is carried out in the form of [symbol] g on a toggle frame, i.e. leather or semifinished product treated according to the [symbol] tion is dried with the aid of fastening means, for example clamps.

[symbol] embodiment of the present invention, drying is effected over a period of up to 16, [symbol] rably up to 12, hours.

[symbol] present invention furthermore relates to formulations comprising
at least one sheet silicate,
at least one copolymer which is obtainable by copolymerization of at least one ethylenically unsaturated dicarboxylic anhydride (A), derived from at least one dicarboxylic acid of 4 to 8 carbon atoms,
at least one vinylaromatic compound (B1) or
at least one oligomer (B2) of branched or straight-chain C₂-C₁₀-alkene, at least one oligomer having an average molecular weight Mₙ of from 300 to 5 000 g/mol or being obtainable by oligomerization of at least 3 equivalents of C₂-C₁₀-alkene,d,

[symbol] [0211] optionally at least one ethylenically unsaturated monomer (C) differing from (A) and having at least one hetero atom,
and reaction with
at least one compound (D) of the formula I a or I b 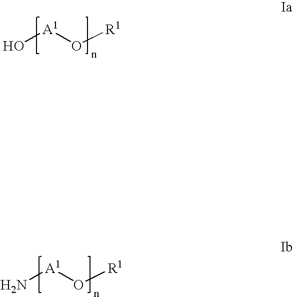
and optionally hydrolysis with water or aqueous alkaline solution,
where, in formulae I a and I b,
A¹ are identical or different and are C₂-C₆-alkylene,
R¹ is linear or branched C₁-C₂₀-alkyl, and
n is an integer from 1 to 200.

In an embodiment of the present invention, novel formulations additionally comprise (c) at least one substance which is selected from
dicarbonyl compounds of the formula II 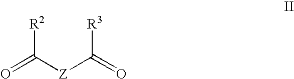
and substances which liberate a dicarbonyl compound of the formula II in the presence of water, where, in the formula II:

R² and R³ are identical or different and are selected from hydrogen, C₁-C₁₂-alkyl, C₃-C₁₂-cycloalkyl, substituted or unsubstituted, C₇-C₁₃-aralkyl, C₆-C₁₄-aryl, substituted or unsubstituted, it being possible in each case for two neighboring radicals to be linked to one another with formation of a ring;

Z is selected from a single bond and bivalent organic groups, which in turn are selected from substituted or unsubstituted C₁-C₁₂-alkylene units, unsubstituted or substituted C₅-C₁₂-cycloalkylene and unsubstituted or substituted C₆-C₁₄-arylene.

Novel formulations are particularly suitable for carrying out that variant of the novel process in which it is desired to use
(a) at least one sheet silicate,
(b) at least one copolymer and
(c) if appropriate, a dicarbonyl compound of the formula II or an adduct used according to the invention
   in a single operation. They can be easily metered and comprise sheet silicate (a), copolymer (b) and, if appropriate, dicarbonyl compound of the formula II or an adduct (c) used according to the invention in the desired ratios.

In an embodiment of the present invention, novel formulations are aqueous formulations.

In an embodiment of the present invention, novel formulations are aqueous formulations having a solids content of from 10 to 80, preferably from 30 to 60, % by weight. In the context of the present invention, solid is defined as the sum of sheet silicate (a), copolymer (b) and dicarbonyl compound of the formula II or an adduct (c) used according to the invention, it being possible for the content of dicarbonyl compound of the formula II and adduct (c) used according to the invention to be zero.

Novel formulations not only permit particularly convenient metering but are also advantageous owing to their shelf-life.

The present invention furthermore relates to the preparation of novel aqueous formulations.

Novel aqueous formulations can be prepared, for example, by mixing sheet silicate (a) and copolymer (b)—before or after hydrolysis—with one another and with further water and, if appropriate, with dicarbonyl compound of the formula II or adduct (c) used according to the invention. It is also possible to use a procedure in which copolymer (b) is first prepared and hydrolyzed and then mixed with sheet silicate (a) and, if appropriate, with dicarbonyl compound of the formula II or adduct (c) used according to the invention.

Novel formulations may furthermore comprise fatliquoring agents, in particular oils, and moreover sulfone tanning agents and fragrances, e.g. citral.

In another embodiment of the present invention, novel formulations are pulverulent formulations.

In another embodiment of the present invention, novel formulations are pulverulent formulations which are obtained by spray-drying.

Novel pulverulent formulations may comprise additives in addition to sheet silicate (a), copolymer (b) and, if appropriate, dicarbonyl compound of the formula II or adduct (c) used according to the invention.

A further subject of the novel process relates to pulverulent formulations comprising from 10 to 100, preferably from 40 to 90, % by weight of the sum of the sheet silicate (a), copolymer (b) and dicarbonyl compound of the formula II or an adduct (c) used according to the invention

and from 0 to 90, preferably from 10 to 60, % by weight of one or more additives.

Suitable additives are as a rule solid particulate substances. They are preferably selected from starch, silica, for example in the form of silica gel, in particular in the form of spheroidal silica gels, alumina and mixed oxides of silicon and aluminum.

Novel pulverulent formulations may consist of fine particles having a mean particle diameter of from 100 nm to 0.1 mm. The particle diameters follow a particle diameter distribution which may be narrow or broad. Bimodal particle size distributions are also conceivable. The particles themselves may have an irregular or spherical shape, spherical particle shapes being preferred. Novel pulverulent formulations can be metered under particularly hygienic conditions in the novel process for the production of leather or semifinished products.

The present invention furthermore relates to a process for the preparation of novel pulverulent formulations. The novel process starts from sheet silicate (a), copolymer (b) and, if appropriate, dicarbonyl compound of the formula II or an adduct (c) used according to the invention which are present in solution, in suspension or in emulsions or as dry material.

In an embodiment of the present invention, dispersions or solutions which are obtained in the preparation of copolymer (b) are used as starting material and are concentrated to a residual water content of 50% by weight or less. They are then mixed with sheet silicate (a) and, if appropriate, dicarbonyl compound of the formula II or an adduct (c) used according to the invention.

In another embodiment of the present invention, reaction solutions as obtained in the preparation of the adducts (c) used according to the invention are used as starting material. It has proven useful to concentrate the reaction solutions to a residual solvent content of 50% by weight or less. They are then mixed with sheet silicate (a) and with copolymer (b).

For the preparation of novel pulverulent formulations, one or more additives are, if desired, furthermore added.

The remaining volatile components are then removed. The resulting liquid, solid or oily concentrated reaction solutions are preferably atomized in a spray dryer, preferably in a spray tower. Spray dryers are known to a person skilled in the art and are described, for example, in Vauck/Müller, Grundoperationen chemischer Verfahrenstechnik, VCH Weinheim, 1988, 7th Edition, pages 638-740 and pages 765-766, and in the literature cited therein.

In an embodiment of the present invention, novel formulations comprise
(a) from 5 to 40, preferably from 10 to 25, % by weight of sheet silicate,
(b) from 5 to 30, preferably from 10 to 20, % by weight of copolymer and
(c) from 20 to 70, preferably from 30 to 50, % by weight of dicarbonyl compound of the formula II or an adduct used according to the invention,
   percentages by weight in each case being based on the total weight of the novel formulation.

The present invention furthermore relates to semifinished products and leather produced by the novel process. Novel semifinished products and leather comprise sheet silicate (a) and copolymer (b). Novel semifinished products and leather have a generally advantageous quality, for example smooth grain, homogeneous tanning over the cross section, improved tensile strength, more homogeneous body and little tendency to discoloration, in particular to yellowing. Novel leather can be better embossed after seasoning. Novel semifinished products can be readily further processed, in particular readily shaved. In particular, adhesion and wear of shaving knives are reduced as is the maintenance requirement of shaving machines.

In a preferred embodiment of the present invention, novel semifinished products and leathers are those which are produced without using chromium-containing tanning agents and without using chromium-containing retanning agents. They have improved resoakability and high resistance to biological contamination, and chromium-free leather wastes, for example shavings, can be utilized, for example as fertilizer, without expensive working-up.

The present invention furthermore relates to the use of novel leather for the production of articles of clothing, for example shoes, jackets, pants, belts and coats. The present invention furthermore relates to a process for the production of articles of clothing, for example shoes, jackets, pants, belts and coats, using novel leather.

The present invention furthermore relates to the use of novel leather for the production of pieces of furniture, for example seats and sofas. The present invention furthermore relates to a process for the production of pieces of furniture, for example seats and sofas, using novel leather.

The present invention furthermore relates to the use of novel leather for the production of automobiles and automotive parts, for example automobile seats, central consoles, dashboards and trims, in automobile interiors.

Particularly in the case of novel leather which is used for the production of automobiles or automotive parts, it is observed that the levelness generally specified in the automotive sector is so good even after the retanning that labor-intensive reshaving can be dispensed with.

The working examples which follow illustrate the invention.

1.a) Delamination Test of Clay Mineral

General Method:

200 g of clay mineral according to table 2 were suspended in 3.8 l of demineralized water in a 10 l vessel. The slurry was heated to 50° C. and stirred using an Ultra-Turrax stirrer from IKA at 250 rpm for 30 minutes.

The particle diameters were determined in each case according to ISO13320-1 by combined laser light diffraction and light scattering. In examples (a.1) to (a.3), in each case monomodal particle diameter distributions were determined.

TABLE 1
Sheet silicates used

| Number | Clay mineral used | Mean particle diameter (number average) |
|---|---|---|
| (a.1) | Bentonite | 0.3 μm |
| (a.2) | Montmorillonite | 0.6 μm |
| (a.3) | Mg hectorite | 0.4 μm |

1.b) Preparation of Copolymer (b) Used According to the Invention

The K values of the copolymers (b) were determined according to H. Fikentscher, Cellulose-Chemie, 13 (1932), 58-64 and 761-774, in aqueous solution at 25° C. and a copolymer concentration of 1% by weight.

1.b.1) Synthesis Method for the Copolymerization for Copolymer (b.1) as an Example

108 g (1.10 mol) of maleic anhydride were dissolved in 550 g (1.10 mol) of D1 (methylpolyethylene glycol having an average molecular weight M_{w} of 500 g/mol) and heated to 90° C. in a nitrogen atmosphere with stirring. At this temperature, 6 g of tert-butyl peroctanoate and a solution of 28 g (0.28 mol) of methyl methacrylate in 114 g (1.10 mol) of styrene were slowly added dropwise in the course of two hours. The reaction mixture obtained was then stirred for 4 hours at 150° C., a brown oil being formed. It was cooled to 50° C. The brown oil was taken up in 500 ml of water and brought to pH 6-7 with 25% strength by weight of sodium hydroxide solution. A 41% strength by weight polymer solution having a low viscosity and a Fikentscher K value of 25 (1% in H₂O) was obtained.

For the preparation of copolymer (b.2), the method was adapted according to table 2.

TABLE 2
Synthesis parameters for the preparation of copolymers (b)

| | (A): Maleic | (B): | | | K value |
|---|---|---|---|---|---|
| | anhydride | Styrene | (C) | (D) | (1% by wt. in |
| Copolymer | [g (mol)] | [g (mol)] | [g (mol)] | [g (mol)] | H₂O) |
| (b.1) | 108 | 86 | Methyl methacrylate | D1 | 25 |
| | (1.10) | (0.84 mol) | 28 (0.28 mol) | 550 (1.10 mol) | |
| (b.2) | 108 | 114 | — | D1 | 33 |
| | (1.10) | (1.10) | | 550 (1.10) | |

A copolymer which was prepared according to EP-B1 0 891 430, example 8, using ortho-xylene as a diluent was used as copolymer (b.3).

1.c) Preparation of Adduct (c.1) Used According to the Invention

The molecular weight determinations were carried out by gel permeation chromatography under the following conditions:

Stationary phase: hydroxyethyl methacrylate gel crosslinked with ethylene glycol dimethacrylate, commercially available as HEMA BIO from PSS, Mainz, Germany. Flow rate: 1.5 ml/min, concentration 1% by weight (based on mobile phase) of adduct (c) in mobile phase with internal standard, mobile phase: tetrahydrofuran (THF) 30% by weight, acetonitrile 10% by weight, 0.1 molar aqueous NaNO₃ solution 60% by weight; internal standard: 0.01% by weight (based on mobile phase) of benzophenone.

In a 1 liter three-necked flask having a condenser, stirrer and thermometer, 128 g of 2-methoxy-2,3-dihydro-4H-pyran (formula II.1; 1.12 mol), 128 ml of water and 112 g of acetone (2 mol) were mixed with 21 g of a 50% strength by weight sulfuric acid and refluxed for 3 hours. The pH was 0.9.

The condenser was then exchanged for a distillation bridge and aqueous acetone was distilled off over a period of 3 hours at 70-80° C. and 1 bar.

The mixture was allowed to cool to room temperature and a pH of 5.2 was established using 25% strength by weight aqueous sodium hydroxide solution. Thereafter, the mixture was transferred to a separating funnel and about 25 ml of an aqueous phase was separated off and discarded. 317 g of adduct (c.1) in the form of an amber-colored oily product having a broad molar mass distribution (Q=5.1) and Mₙ of 610 g were obtained.

2. Preparation of Novel Aqueous Formulations

2.1 Preparation of Novel Aqueous Formulation F2.1

In a 2 l container, 180 g of sheet silicate (a.1) were thoroughly mixed with 340 g of 40% strength by weight aqeuous solution of copolymer (b.1) and 550 g of a 50% strength by weight aqueous solution of glutaraldehyde

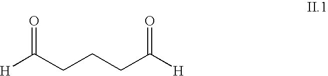

Thereafter, 80 g of rapeseed oil were added to the resulting dispersion, a pH of 6 was established with the aid of 10% by weight of H₂SO₄ and the formulation was stirred for a further 10 minutes with the aid of an Ultra-Turrax stirrer.

2.2 Preparation of Novel Formulation F2.2

In a 2 l container, 160 g of sheet silicate (a.2) were thoroughly mixed with 350 g of a 40% strength by weight aqueous solution of copolymer (b.3) and 530 g of a 50% strength by weight aqueous solution of glutaraldehyde

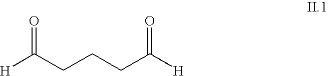

Thereafter, 40 g of liquid paraffin were added to the resulting dispersion and the formulation was stirred for a further 10 minutes with the aid of an Ultra-Turrax stirrer.

2.3 Preparation of Novel Aqueous Formulation F2.3

In a 2 l container, 180 g of sheet silicate (a.3) were thoroughly mixed with 340 g of a 38% strength by weight aqueous solution of copolymer (b.2) and 520 g of a 55% strength by weight aqueous solution of adduct (c.1). Thereafter, a pH of 6 was established with the aid of 10% by weight of H₂SO₄ and the formulation was stirred for a further 10 minutes with the aid of an Ultra-Turrax stirrer.

3. Novel Treatment of Pickled Pelts

Data in % by weight are based on the pickled weight, unless stated otherwise.

3.1 Novel Treatment with Formulation 2.1

5 l of aqueous NaCl solution (6 Bé) were added to pickled pelts from cattle sides (pickled weight about 6 kg each) having a split thickness of 2.5 mm at a pH of 3.0-3.2 and 25° C. in a rotatable 10 l drum containing baffles and drumming was then effected.

After 30 minutes, 3.5% by weight of novel formulation F2.1 were added and, after 45 minutes, 3% by weight of a sulfone tanning agent from EP-B 0 459 168, example K1. After a drumming time of a further 90 minutes, a 2:1 mixture (weight ratio) of naphthalenesulfonic acid/formaldehyde condensate, prepared according to U.S. Pat. No. 5,186,846, example entitled “Dispersant 1” and sodium formate was added in portions over a period of 4 hours until a pH of 4 had been established.

The liquor was discharged, and the semifinished products obtained were washed twice with water, partly dried, and shaved to a split thickness of 1.8 mm.

For examples 3.2 and 3.3 (according to the invention) and C3.4 (comparative example), the treatment was repeated but formulation 2.2, 2.3 or C2.4, respectively, was used.

The comparative experiment C4 was carried out analogously, but 3.5% by weight of a 24% strength by weight aqueous glutaraldehyde solution was added instead of novel formulation.

Testing of performance characteristics of the novel semifinished products (cf. table 3):

The shavability was determined by experiments on a shaving machine. Shaving machines operate with rotating knives. In the case of poor shavability, the knives scrape over the surface and there is a temperature increase in the surface of the leather so that melting of horny substance irreversibly damages the hide. The rating of the shavability was effected according to a rating system from 1 (very good) to 5 (poor) and 6 (inadequate).

The shrinkage temperatures were determined according to the method from DIN 53 336 (year 1977), the method being modified as follows:
Point 4.1: The specimens had the dimensions 3 cm·1 cm; the thickness was not determined.
Point 4.2: Only one specimen instead of 2 specimens per leather sample was tested.
Point 6: Omitted
Point 7: The drying in a desiccator under reduced pressure was omitted.

Point 8: The shrinkage temperature was measured when the pointer traveled back.

TABLE 3
Result of the tanning and analytical evaluation of the novel semifinished
products

| | Semifinished | | Shrinkage |
|---|---|---|---|
| Formulation | product | Shavability | temperature [° C.] |
| 2.1 | 3.1 | 1 | 76 |
| 2.2 | 3.2 | 1 | 75 |
| 2.3 | 3.3 | 1 | 77 |
| C 4 | C 3.4 | 3 | 74 |

4. Production of Novel Leather and Comparative Experiment

Data in % by weight are based on the shaved weight, unless stated otherwise. Semifinished products 3.1 and 3.3 were each halved. One half was dried in a dryer under reduced pressure for 10 minutes at 45° C. and 80 mbar and are referred to below as semifinished products 3.1T and 3.3T, respectively.

4.1 Production of Leather 4.1 from Semifinished Product 3.1

Semifinished product 3.1 was drummed together with the following agents for 30 minutes:

150% by weight of water,

5% by weight of the sulfone tanning agent from EP-B 0 459 168, example K1, and 4% of a 30% strength by weight aqueous solution of a methacrylic acid homopolymer, partially neutralized with NaOH and having the following analytical data: Mₙ about 10 000; Fikentscher K value: 12 (determined as a 1% strength by weight aqueous solution); viscosity of the 30% strength by weight solution: 65 mPa·s (DIN EN ISO 3219, 23° C.), pH: 5.1.

6% by weight of the vegetable tanning agent Tara® (BASF Aktiengesellschaft) and 2% by weight of the resin tanning agent Relugan® S (BASF Aktiengesellschaft) and 2% by weight of an aqueous solution comprising 50 parts by weight (solids content) of dyes whose solids in turn had the following composition:

70 parts by weight of dye from EP-B 0 970 148, example 2.18,

30 parts by weight of Acid Brown 75 (iron complex), Color Index 1.7.16.

Drumming was then carried out for a further 2 hours at 30° C. Thereafter, 6% by weight of a fat were then metered in liquoring agent which had been prepared as described under 5 were added and drumming was effected for a further 60 minutes. Thereafter, a pH of 3.2 was established with formic acid, samples for determining the liquor exhaustion were taken and the liquors were discharged.

The novel leather 4.1 thus obtainable was washed twice with 100% by weight of water each time, stored moist overnight, drummed and then dried on a toggle frame at 50° C. The leather was then staked. After the staking, leather 4.1 was assessed as below.

Evaluation was effected according to a rating system from 1 (very good) to 5 (poor). The evaluation of the liquor exhaustion was effected visually according to the criteria of residual dye (extinction) and turbidity (fatliquoring agent), from which the mean value was calculated.

### EXAMPLES 4.2 TO 4.3, COMPARATIVE EXAMPLE C 4.4

The above procedure was repeated, but in each case with the novel semifinished products 3.2 and 3.3 or comparative semifinished product C 3.4. The novel leathers 4.2 and 4.3 and comparative leather C 4.4 were obtained.

### EXAMPLES 4.1T AND 4.3T

The above procedure was repeated in each case with the dried semifinished products 3.1T and 3.3T, but in each case 170% by weight of water were used instead of 150% by weight of water. The novel leathers 4.1T and 4.3T were obtained.

The evaluation of the performance characteristics is shown in table 4.

TABLE 4
Evaluation of performance characteristics of novel leathers and
comparative leathers

| | Liquor | | Grain | | Tensile strength |
|---|---|---|---|---|---|
| Leather | exhaustion | Body | tightness | Softness | [N] |
| 4.1 | 2 | 2 | 1.5 | 2.5 | 286 |
| 4.1T | 1.5 | 2 | 2 | 2.5 | 289 |
| 4.2 | 2 | 1.5 | 2 | 2 | 294 |
| 4.3 | 1.5 | 1.5 | 1.5 | 1.5 | 289 |
| 4.3T | 1 | 1 | 1.5 | 1 | 286 |
| C 4.4 | 3 | 3.5 | 3.5 | 3 | 274 |

The tensile strength was determined according to DIN 53328.

5. Preparation of the Fatliquoring Agent from Examples 4.1 to 4.4

The following were mixed in a 2 l vessel:

230 g of a polyisobutene having Mₙ=1 000 g/mol and M_{w}=2000 g/mol

30 g of n-C₁₈H₃₇O—(CH₂CH₂O)₂₅—OH

5 g of n-C₁₈H₃₇O—(CH₂CH₂O)₈₀—OH

40 g of oleic acid

230 g of sulfited oxidized triolein

The mixture was heated to 60° C. with stirring, and 470 g of water and 10 g of n-C₁₆H₃₃O—(CH₂CH₂O)₇—OH were added. The resulting emulsion was then passed through a gap homogenizer. A finely divided, stable emulsion was obtained.

1. A process for the production of semifinished products or leather, wherein pelts, pickled pelts or semifinished products are treated with
a) at least one sheet silicate and
b) at least one copolymer which is obtained by copolymerization of
at least one ethylenically unsaturated dicarboxylic anhydride (A), derived from at least one dicarboxylic acid of 4 to 8 carbon atoms,
at least one vinylaromatic compound (B 1) or
at least one oligomer (B2) of branched or straight-chain C₂-C₁₀-alkene, at least one oligomer having an average molecular weight Mₙ of from 300 to 5 000 g/mol or being obtainable by oligomerization of at least 3 equivalents of C₂-C₁₀-alkene,
and
optionally at least one ethylenically unsaturated monomer (C) differing from (A) and having at least one hetero atom,
and reaction with
at least one compound (D) of the formula I a or I b 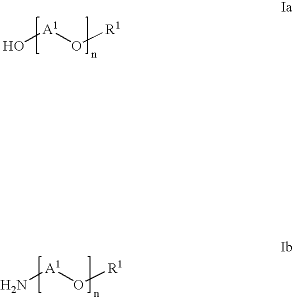
and optionally hydrolysis with water or aqueous alkaline solution,
where, in formula I a and I b,
A¹ are identical or different and are C₂-C₆-alkylene
R¹ is linear or branched C₁-C₂₀-alkyl and
n is an integer from 1 to 200.

2. The process according to claim 1, wherein pelts, pickled pelts or semifinished products are additionally treated with
c) at least one substance which is selected from
dicarbonyl compounds of the formula II 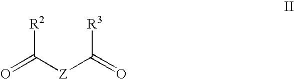
and substances which liberate a dicarbonyl compound of the formula II in the presence of water, where, in formula II,
R² and R³ are identical or different and are selected from hydrogen, C₁-C₁₂-alkyl, C₃-C₁₂-cycloalkyl, substituted or unsubstituted, C₇-C₁₃-aralkyl, C₆-C₁₄-aryl, substituted or unsubstituted, it being possible in each case for two neighboring substituents to be linked to one another with the formation of a ring;
or R² and R³ are linked to one another with formation of a ring,
Z is selected from a single bond and bivalent organic groups, which in turn are selected from substituted or unsubstituted C₁-C₁₂-alkylene units, unsubstituted or substituted C₅-C₁₂-cycloalkylene and unsubstituted or substituted C₆-C₁₄-arylene.

3. The process according to claim 2, wherein Z is 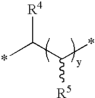
where
R⁴ is selected from hydrogen, C₁-C₁₂-alkyl, C₃-C₁₂-cycloalkyl, substituted or unsubstituted, C₇-C₁₃-aralkyl, C₆-C₁₄-aryl, substituted or unsubstituted,
y is an integer from 1 to 4, and
R⁵ are identical or different and are selected from hydrogen, C₁-C₁₂-alkyl, C₃-C₁₂-cycloalkyl, substituted or unsubstituted, C₇-C₁₃-aralkyl, C₆-C₁₄-aryl, substituted or unsubstituted, it being possible for R⁴ with neighboring R⁵ or in each case two neighboring radicals R⁵ to be linked to one another with the formation of a ring.

4. The process according to claim 2, wherein at least one substance which liberates a dicarbonyl compound of the formula II in the presence of water is obtainable by reacting at least one carbonyl compound of the formula III 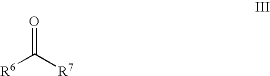
where
R⁶ and R⁷ are identical or different and are selected from hydrogen, C₁-C₁₂-alkyl, C₃-C₁₂-cycloalkyl, substituted or unsubstituted, C₇-C₁₃-aralkyl, C₆-C₁₄-aryl, substituted or unsubstituted, it being possible for R⁶ and R⁷ to be linked to one another with formation of a ring,
with at least one dicarbonyl compound of the formula II and with at least one cyclic compound of the formula IV a or IV b 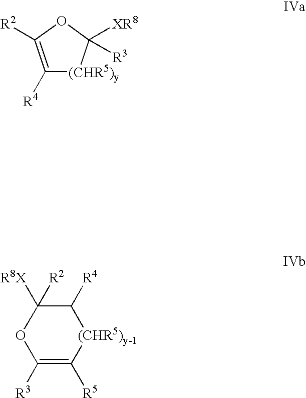
where
X is selected from oxygen, sulfur and N—R⁸, and
R⁸ are identical or different and are selected from hydrogen, C₁-C₁₂-alkyl, C₃-C₁₂-cycloalkyl, substituted or unsubstituted, C₇-C₁₃-aralkyl, C₆-C₁₄-aryl, substituted or unsubstituted, formyl, CO—C₁-C₁₂-alkyl, CO—C₃-C₁₂-cycloalkyl, substituted or unsubstituted, CO—C₇-C₁₃-aralkyl, CO—C₆-C₁₄-aryl, it being possible for R² and R⁸ or R⁵ and R⁸ to be linked to one another with formation of a ring and, where X is N—R⁹, it being possible for two radicals R⁸ to be linked to one another with formation of a ring.

5. The process according to claim 2, wherein X is oxygen.

6. The process according to claim 2, wherein, in formula IV a, R² to R⁵ are each hydrogen and R⁸ is methyl.

7. The process according to claim 1, wherein styrene is selected as a vinylaromatic compound (B 1) in at least one copolymer (b).

8. The process according to claim 1, wherein a sheet silicate having a number average particle diameter of up to 2 μm is used as the sheet silicate (a).

9. The process according to claim 1, wherein drying to a residual water content of 45% by weight or less is effected after the treatment with (a), (b) and, if appropriate, (c).

10. A formulation comprising
a) at least one sheet silicate and
b) at least one copolymer which is obtained by copolymerization of
at least one ethylenically unsaturated dicarboxylic anhydride (A), derived from at least one dicarboxylic acid of 4 to 8 carbon atoms,
at least one vinylaromatic compound (B1) or
at least one oligomer (B2) of branched or straight-chain C₂-C₁₀-alkene, at least one oligomer having an average molecular weight Mₙ of from 300 to 5 000 g/mol or being obtainable by oligomerization of at least 3 equivalents of C₂-C₁₀-alkene,
and
optionally at least one ethylenically unsaturated monomer (C) differing from (A) and having at least one hetero atom,
and reaction with
at least one compound (D) of the formula I a or I b 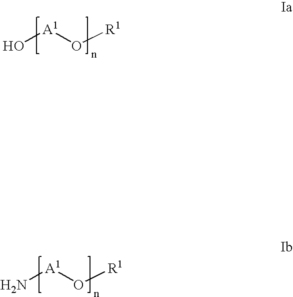
and optionally hydrolysis with water or an aqueous alkaline solution, where, in formulae I a and I b,
A¹ are identical or different and are C₂-C₆-alkylene,
R¹ is linear or branched C₁-C₂₀-alkyl, and
n is an integer from 1 to 200.

11. The formulation according to claim 10, additionally comprising
at least one substance which is selected from
dicarbonyl compounds of the formula II 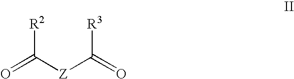
and substances which liberate a dicarbonyl compound of the formula II in the presence of water, where, in the formula II,
R² and R³ are identical or different and are selected from hydrogen, C₁-C₁₂-alkyl, C₃-C₁₂-cycloalkyl, substituted or unsubstituted, C₇-C₁₃-aralkyl, C₆-C₁₄-aryl, substituted or unsubstituted, it being possible in each case for two neighboring radicals to be linked to one another by formation of a ring,
Z is selected from a single bond and a bivalent organic group which in turn are selected from substituted or unsubstituted C₁-C₁₂-alkylene units, unsubstituted or substituted C₅-C₁₂-cycloalkylene, unsubstituted or substituted C₆-C₁₄-arylene.

12. The formulation according to claim 10, which is an aqueous formulation.

13. The formulation according to claim 10, which is a pulverulent formulation.

14. A process for the preparation of the formulation according to claim 10, wherein
a) at least one sheet silicate and
b) at least one copolymer and, optionally
c) at least one dicarbonyl compound of the formula II or
at least one substance which liberates a dicarbonyl compound of the formula II in the presence of water are mixed with one another.

15. A process for the preparation of the pulverulent formulation according to claim 13, wherein said formulation is obtained by spray-drying.

16. A semifinished product or leather produced by a process according to claim 1.

17. A method for the production of articles of clothing, pieces of furniture and automobiles and automotive parts comprising utilizing the semifinished product or leather produced by the process according to claim 1 to produce clothing, furniture, an automobile and an automobile part.
